(19) United States
(12) Patent Application Publication
(10) Pub. No.: US 2022/0083666 A1
(43) Pub. Date: Mar. 17, 2022

(54) KEY AUTHENTICATION

(71) Applicant: Hewlett-Packard Development Company, L.P., Spring, TX (US)

(72) Inventors: Thalia Laing, Bristol (GB); Adrian John Baldwin, Bristol (GB); Joshua Serratelli Schiffman, Bristol (GB)

(73) Assignee: Hewlett-Packard Development Company, L.P., Spring, TX (US)

(21) Appl. No.: 17/414,836

(22) PCT Filed: Jun. 3, 2019
(86) PCT No.: PCT/US2019/035213

§ 371 Date: Jun. 16, 2021

(51) Int. Cl. G06F 21/57; H04L 9/08; H04L 9/32; G06K 19/06

(52) U.S. Cl. CPC G06F 21/575; H04L 9/0877; H04L 9/3247; G06F 2221/034; H04L 9/3271; G06K 19/06037; H04L 9/3215

(57) ABSTRACT

In an example there is provided a method to certify a cryptographic key. The method comprises accessing an identifier stored at a secure location on the computing device, generating a cryptographic key according to a key generation process and certifying the cryptographic key is authentically generated during the boot process of the computing device, on the basis of the identifier.

### BACKGROUND

Cryptographic protocols are used to secure communications and authenticate users in an untrusted environment. Public key cryptosystems use pairs of keys: public keys which are disseminated widely across networks, and private keys which are known to the owner and no one else. Public key cryptosystems alone are not sufficient to allow users to trust one another in a network. A public key infrastructure may be used to authenticate users. In a public key infrastructure, each user applies to a certificate authority for a digital certificate which serves for other users as a non-tamperable authentication of the identity of the user. Certificate authorities act as a trusted third party which everyone in the network trusts.

### BRIEF DESCRIPTION OF THE DRAWINGS

Various features of certain examples will be apparent from the detailed description which follows, taken in conjunction with the accompanying drawings, which together illustrate, by way of example, a number of features, wherein:

FIG. 1 shows an apparatus for generating a cryptographic key, according to an example.

FIG. 2 shows a block diagram of a method for generating a cryptographic key, according to an example.

FIG. 3 shows a schematic diagram of a challenge and response protocol, according to an example.

FIG. 4 shows a processor associated with a memory and comprising instructions for authenticating a cryptographic key on a computing device, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Cryptography has is widely used in modern communications technology such as mobile and network communication systems. Cryptographic protocols are used to secure communications channels between parties and authenticate users to one another. Encryption protocols provide data security and digital signatures are used to authenticate messages sent between parties.

The security of modern cryptosystems relies on the secrecy of a key. Early cryptosystems employed symmetric key algorithms, in which the same key was used by both the sender and the recipient. In symmetric cryptosystems the key had to be exchanged between the communicating parties in some secure way prior to any use of the system either in person or via a secure channel. It becomes unmanageable for a large number of parties to use symmetric key encryption when secure channels are not available for key exchange, or when keys are frequently being changed. The number of keys grows exponentially with the number of users.

Public key cryptography is an alternative to symmetric key cryptography where a user generates a public key together with the private key. The public key may be communicated over an insecure channel to any party. In public key encryption, the public key allows anyone in possession of the public key to encrypt data using the public key. The owner of the corresponding private key may decrypt the ciphertexts encrypted with the public key. No other parties can decrypt the data.

Another primitive used in secure communications are key exchange algorithms. The Diffie-Hellman key exchange algorithm is a public key algorithm allows two parties that have no prior knowledge of each other to jointly establish a shared secret key over an insecure channel. This allows the use of efficient symmetric key cryptography in a situation where previously a secure channel would have been used.

Diffie-Hellman key exchange, when used alone, is vulnerable to so-called man in the middle attacks. This is because Diffie-Hellman is an unauthenticated protocol. It does not provide cryptographic assurance to the sender or recipient of messages that the messages originate with the true recipient or sender respectively. A party acting as a man in the middle can intercept communications between parties, forward messages back and forth and possibly tamper with or inject messages between the sender and receiver.

To overcome this, assurance that public/private key pairs used in the key exchange algorithm have originated from the true owners of the keys can be used. For example, certificate authorities can certify that a cryptographic key has been generated by a certain party. The certificate authority may issue a public key certificate, also known as a digital certificate or identity certificate, which is an electronic document used to prove the ownership of a public key. The certificate includes information about the key, information about the identity of its owner, and the digital signature of an entity, also known as the issuer, that has verified the certificate's contents.

In certain circumstances an entity may not be equipped to securely store a long-term, static private key. In such circumstances ephemeral key exchange can be used. Ephemeral keys are keys which are used for a short period of time. This may be once, or multiple times per session. However, an ephemeral key is not stored long term.

When using ephemeral keys in a key exchange protocol such as Diffie Hellman key exchange it may be challenging to authenticate the keys using a certificate authority every time a new ephemeral key is generated. For example, in the case where a key is generated during a start-up procedure in which the device generating the key does not have access to networking functionality.

The methods and systems described herein can, according to an example, be used to authenticate ephemeral keys through the use of a long-term, securely stored, static, and certified hardware-based device identifier in the form of a secret key associated to the physical device. In an example, a hardware-based device identity can be used to certify ephemeral keys during key negotiation, for example, using cryptographic signatures. This binds the ephemeral key to the physical identity of the device. The public key corresponding of the hardware-based device identifier/secret key is then received out of band, allowing a user to verify the identity of the hardware and link ephemeral keys to a root of trust of the physical device. Effectively the device certifies its own keys using the root of trust of the device.

A long-term hardware-based device identifier can be stored on certain devices where a static key may not be stored. For example, some computing devices have embedded hardware components such as trusted platform modules. These modules can store an identifier in a controlled and restricted manner. Re-using an actual key in a key exchange session poses a security risk and is therefore advised against. Hence, in an example, the identifier can be stored and ephemeral keys signed rather than reusing the same long-term stored key in the key exchange protocol itself.

The methods and systems described herein differ from systems based on communication with a certificate authority. In many situations, a certificate authority may not be available to certify ephemeral keys. The system described herein asserts whether an ephemeral key is genuinely generated on the physical device during a boot process of the computing device. This functionality can be provided with a hardware-based device identifier.

Additionally, if there is an enterprise entity, who does not necessarily have a physical relationship with the device like the user managing the device does, a hardware-based device identifier enables the enterprise to relate the identifier to an actual physical device. Without a hardware-based device identifier, the enterprise would have to trust the user that the ephemeral key they see is tied to the physical device that the user is in front of. There is nothing to prevent the user generating a different key pair themselves and sending this information to the enterprise claiming it is tied to their device.

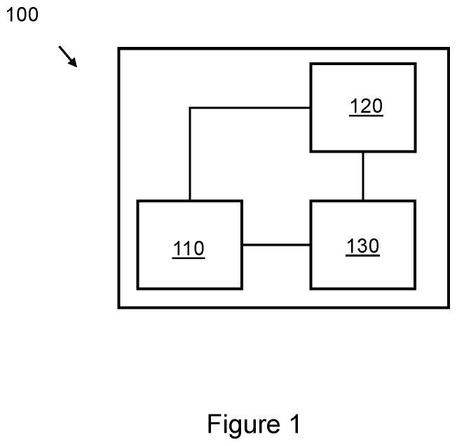

FIG. 1 shows an apparatus 100, for generating a cryptographic key according to an example. In examples described herein, the apparatus 100 shown in FIG. 1 is a computing device such as a personal computer, laptop or mobile device.

The apparatus 100 is used in conjunction with the other methods and systems described herein. In particular, the apparatus 100 is arranged to generate cryptographic keys such as ephemeral keys for use in a key exchange protocol, such as the Diffie Hellman key exchange protocol. These keys may be used to generate further keys for use in symmetric key cryptographic protocols that can be used for secure communication between parties.

The apparatus 100 shown in FIG. 1, comprises a tamper proof module (TPM) 110, such as a trusted platform module for example. In the example of the apparatus 100 it is assumed that the TPM 110 comprises a secure data storage (not shown). Access to a part or whole of the data stored in the secure storage may be controlled or restricted. For example, in some cases, the data held on the TPM is read only data for some or all of the other components of the apparatus 100.

In some examples, the manufacturer of the TPM 110 or apparatus 100 writes data into the TPM. In other cases, parties with access rights to the data held on the TPM 110 may be able to perform read and write operations into and out of the TPM 110.

TPMs have varying capabilities and features. In some cases, the TPM 110 has crypto-processing capabilities. For example, the TPM 110 may be able to encrypt data using a key or keys stored in the secure storage. In other examples the TPM 110 is able to generate cryptographic signatures on data stored elsewhere on the apparatus 100. In further examples, the TPM 110 is able to securely compute hash values of data using a hash function.

The apparatus 100 comprises a processor 120 that is communicatively coupled to the TPM 110. The processor 120 is a general purpose processor arranged to perform operations on data held on the apparatus 100. For example, the processor 120 may be arranged to retrieve or read data that is securely stored on the TPM 110.

In examples described herein, the processor 120 is arranged to execute a boot process when the apparatus 100 is powered on. Herein, a boot process is a process executed by the apparatus 100 to load an operating system. In some examples, a boot process may be initiated by a small boot loader program stored in read only memory (not shown) of the apparatus 100.

In examples described herein, the processor 120 executes a trusted boot process in conjunction with the TPM 110. A trusted boot process is a boot process in which a user can be assured of the integrity of the sequence of operations executed during a boot cycle. That is to say, the operations performed by the processor 120 in conjunction with the TPM 110 are verifiably performed and, in some cases assurance, for example, in the form of hash values of inputs and outputs, may be provided to a user that the sequence of operations has not be altered or tampered with. In particular, the state of the apparatus 120 at a given point in the boot cycle is a trusted state.

The apparatus 100 further comprises a cryptographic key generation module 130. The cryptographic key generation module 130 is communicatively coupled to the processor 120 and TPM 110. In examples described herein the cryptographic key generation module 130 is separate from the processor 120 and TPM 110. However, in some examples of TPMs certain cryptographic functions may be performed, including key generation. Similarly, key generation may be performed by a general purpose processor such as processor 120. In such cases apparatus 100 may comprise the TPM 110 and processor 120 without the cryptographic key generation module 130.

The processor 120 is arranged to control the cryptographic key generation module 130. In particular, the processor 120 communicates instructions to the cryptographic key generation module 130 to execute a cryptographic key generation process. According to examples of the methods described herein, the processor 120 is arranged to initiate key generation during a trusted boot process. In this way, the processor 120 may control the generation of ephemeral cryptographic keys in a trusted boot process in conjunction with the cryptographic key generation module 130. The user of the apparatus 100 can be assured that an ephemeral key which is output from the cryptographic key generation module 130 is created in a trusted sequence of operations.

Even though the user can trust the sequence of operations itself, it is not sufficient to tie the sequence of operations to the device. The ephemeral key output by the cryptographic key generation module 130 should also be authenticated.

During booting, the apparatus 100 and processor 120 perform a certain subset of functions of those functions which the apparatus can perform when it is fully operational. In particular, for example, it may not be possible for a cryptographic key to be generated and certified in the usual ways via a certificate authority while the apparatus 100 is operating in a trusted state.

In examples described herein, the processor 120 is further arranged to authenticate cryptographic keys generated by the cryptographic key generation module 130 during the trusted boot process, on the basis of an identifier securely stored on TPM 110. According to examples described herein, the processor 120 accesses the TPM 110. The actual sequence of operations to perform the authentication to certify the ephemeral key may take place inside the TPM 110, if the TPM 110 has the functionality to perform those operations. Else cryptographic authentication of the ephemeral key takes place on the processor 120.

According to one example, the processor 120 can use the identifier stored in the TPM to execute a cryptographic signing operation to generate a cryptographic signature on the ephemeral key. A cryptographic signature ties the ephemeral key to the device. The signature is independently verifiable by external entities.

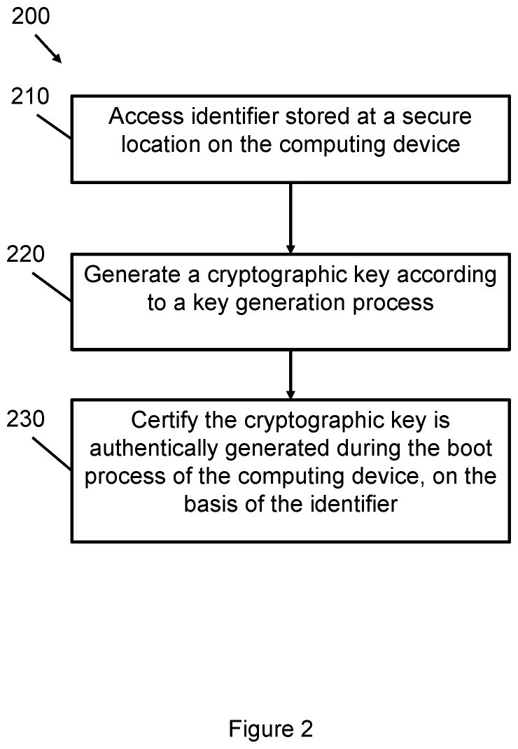

FIG. 2 shows a method of method 200 of generating a cryptographic key during a boot process of a computing device, according to an example. The method 200 shown in FIG. 2 may be implemented on the apparatus 100 shown in FIG. 1.

At block 210 an identifier that is stored at a secure location on the computing device is accessed. According to examples described herein, when the method 200 is implemented on the apparatus 100, shown in FIG. 1, the secure storage is provided for by the TPM 110. In other examples, the secure storage may be provided in region of main memory, or hard disk space of the computing device.

At block 220, a cryptographic key is generated according to a key generation process. The key generation process may be initiated by the cryptographic key generation module 130 shown in FIG. 1. Such a key generation process can be executed in software or by a dedicated hardware component.

Any kind of asymmetric cryptographic key generation algorithm may be used in conjunction with the methods described herein. For example, keys generated using RSA, elliptic curve or lattice based key generation algorithms may be implemented. Keys of any size may be used, for example, a 1024-bit RSA key provides a security level of 80 bits. For keys based on points of elliptic curves, comparable 80-bit security levels may be achieved with 160-bit keys. Thus, elliptic curve cryptography may be used in memory constrained or lightweight applications, or for the purposes of computational efficiency.

At block 230, the cryptographic key is certified to prove that it was authentically generated during the boot process of the computing device. The certification of the cryptographic key is performed on the basis of the identifier. According to examples described herein, certifying the cryptographic key comprises generating a cryptographic signature on the cryptographic key, based on the identifier.

Since operations in the method 200 are performed during a boot process, if the boot process is a trusted boot process, certification of the key according to the method 200 is also trusted, since the identifier is assumed to be linked to a root of trust of the computing device.

In an alternative of the method 200 shown in FIG. 2, block 210 may be performed prior to initiating a boot process. In particular, the identity may be accessed from the secure location prior any boot loader has been loaded into memory of the computing device. However, additional precautions should be taken to ensure that the read operations are trusted if such an alternative is implemented.

The method 200 may further comprise verifying the cryptographic is a key which has authentically been generated by the computing device. Verification of the key is performed, in some case, on the computing device. For example, a user wishing to execute secure communication with another user may wish to verify that an ephemeral key on the computing device was generated by the computing device during a trusted booting process. The user can verify the key according to the method 200 described herein. For example, in a case where the certification of the key comprises providing a cryptographic signature on the key, the user can verify the cryptographic signature using a corresponding public key.

If the user of the device is not the manufacturer then they cannot simply trust that the identifier is linked to the computing device. This should therefore be independently verifiable by the user.

A method is described whereby a user can verify that the identifier is linked to the computing device. According to an example, the computing device implementing the method 200 can generate a cryptographic signature based on the serial number of the computing device, where the signature is generated using the identifier that is purportedly linked to the computing device. This signature may be sent to the device manufacturer.

In response to receiving the signature, the device manufacturer provides a certified public key out of band on the basis of the serial number, where the certified public key is the corresponding public key associated to the identifier. In this case, the identifier itself can be used as a secret key, or can be used to generate a secret key to sign the serial number. The user can then verify the signature on the serial number using the certified public key.

If an enterprise entity is managing the system, the enterprise can be made aware of the serial number and the hardware-based ID certificate. The enterprise can communicate with the manufacturer before the device is deployed to the user, for example, and then both store and pass the certificate to the user. If/when the enterprise communicates with the device (potentially via the user), the enterprise can be sure that the ephemeral key it is communicating with is tied to the physical device, and if the user elicits input from the enterprise to authenticate, the enterprise learns which device the user is authenticating to.

In a further example, a user can verify the identifier as follows: a cryptographic signature on the serial number can be provided pre-installed on the computing device. When the user wishes to link the identifier to the computing device the user can receive a public key from the device manufacturer out of band. The cryptographic signature can then be verified by the user.

An example of a protocol is described herein that allows an authorised user to authenticate in a password-less manner to the Basic Input/Output System (BIOS) of a computing device. This protocol may be used to allow an authenticated user to perform low level BIOS management operations for example.

In an example, a user receives a public/private key pair from the device. In an authentication stage, the user can be presented with a machine-readable optical code such as, for example, a matrix barcode such as a Quick Response (QR) code, on a screen of the device, which is an encrypted challenge. If the user can decrypt the challenge, using the previously received private key, and input the challenge (or a fingerprint of the challenge) into the device, the user can be successfully authenticated.

A malicious application on a computing device could present the user with a screen, masquerading as the BIOS, and present the user with a public key which the user wrongly believes belongs to the device. The user would then calculate a shared key with the malicious application, rather than with the BIOS, as they expect. Such an adversarial application could conduct a ‘denial’ style attack, preventing the user from modifying the BIOS settings without them realizing.

An additional attack could involve a man in the middle attack whereby the malicious application on the device communicates the information input by the user to an adversary who is in control of the device the user is authorised to modify, but the adversary is not. In this way, the attacker could gain access to the BIOS of a device they are not authorised to enter.

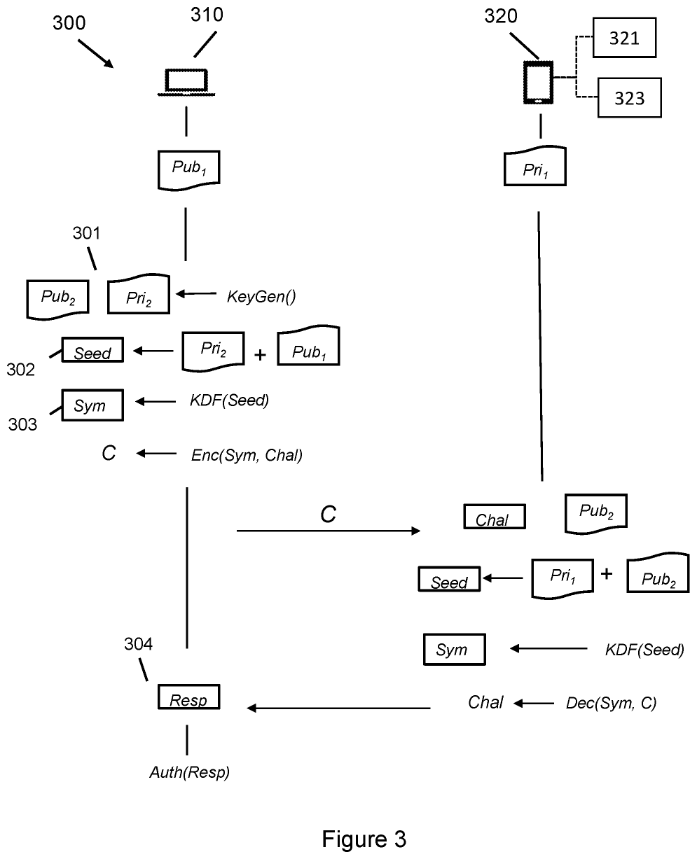

FIG. 3 shows an example of the challenge and response protocol 300 which may be implemented in conjunction with the systems described herein. In the example of FIG. 3, the protocol 300 is executed between a computing device 310 and user device 320, which may be a smartphone for example, and which can include a display 321 and imaging apparatus 323 such as a camera for example. The protocol may be used to authenticate a user to enable them to execute boot management operations securely on the computing device 310, independently of any certificate authority authorizing cryptographic keys. Communication between the computing device 310 and user device 320 is restricted during the boot phase. The computing device 310 may display codes using a display device 321 of the device 310. As noted above, such codes can be, for example, QR codes. The user device 320 can read the codes with the device 320, e.g. using an imaging apparatus 323 of the device 320. In the boot phase, the communication channel from the user to the BIOS of device 310 is use of the keyboard.

In the example shown in FIG. 3, the user device 320 initially holds a private key Pri₁ and the computing device 310 holds a corresponding public key Pub₁ where (Pub₁, Pri₁) are generated according to a key generation algorithm KeyGen( ). According to examples, the devices 310, 320 may be configured to hold the public and private keys in an initial enrolment phase of the protocol 300. An enrolment phase may be initiated by, for example, a trusted management system that generates and communicates the respective keys to the devices.

In the challenge and response stage of the protocol the computing device 310 generates a further key pair (Pub₂, Pri₂) 301. The computing device 310 generates a seed 302 based on a combination of Pub₁ and Pri₂. The seed 302 is used as input to a key derivation function KDF( ) to generate a symmetric key Sym 303. A challenge chal is randomly generated and is encrypted using the key Sym, to generate an encryption C which is communicated to the user device 320

The user device 320 can receive the challenge together with the public part of the computing device 310 key, Pub₂. The user device 320 computes the same seed using Pub₂ with their private key, Pri₁. The seed 302 is then used to compute the symmetric key Sym 303 which the user can use to decrypt the challenge ciphertext C. The response Resp 304 is entered on the computing device 310. For example, the user can type the response into the device 310 using a keyboard. The received challenge is verified by the computing device 310.

When the method 200 is used in conjunction with protocol 300 to certify the keys shared with the user device, the user can be assured that they are interacting with the computing device during its boot process and not some other malicious application. The use of method 200 in conjunction with protocol 300 also defends a user from the man in the middle attack scenario previously described.

The methods and system described herein provide a method for certifying, in a trustworthy manner, ephemeral cryptographic keys for use in further cryptographic protocols on a computing device. The methods described may be used in a situation where a certificate authority is not available to certify keys, such as in a trusted boot phase of a computing device. Advantageously, the methods and systems described herein allows a user to trust keys generated on the fly on their device, from the moment the device is powered on. Using a hardware-based device identifier in the manner described herein allows enterprise users to have confidence in the identity of their devices and securely establish shared secrets for secure communications. Enterprise users can also be given more control over their devices, meaning they would have to place less trust in the users.

Examples in the present disclosure can be provided as methods, systems or machine-readable instructions. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted.

Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry.

The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

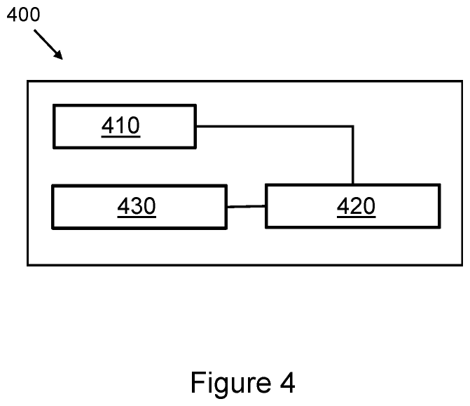

FIG. 4 shows an example of a processor 410 associated with a memory 420. The memory 420 comprises computer readable instructions 430 which are executable by the processor 410. The instructions 430 comprise instruction to, retrieve a hardware-based digital signing key from a secure storage on a computing device; and authenticate a cryptographic key generated according to a cryptographic key generation algorithm, during a boot process of the computing device, on the basis of the hardware-based digital signing key.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for generating a cryptographic key, comprising, during a boot process of a computing device:
accessing an identifier stored at a secure location on the computing device;
generating a cryptographic key according to a key generation process; and
certifying the cryptographic key is authentically generated during the boot process of the computing device, on the basis of the identifier.

2. The method of claim 1, wherein certifying the cryptographic key comprises:
generating a cryptographic signature on the cryptographic key based on the identifier.

3. The method of claim 1, comprising:
verifying a cryptographic key is authentically generated by the computing device.

4. The method of claim 3, wherein verifying the key pair comprises:
verifying a cryptographic signature on the cryptographic key based on the identifier.

5. The method of claim 1 comprising determining whether the identifier is linked to the computing device.

6. The method of claim 5, wherein determining whether the identifier is linked to the computing device comprises:
generating a cryptographic signature of a serial number of the computing device;
communicating the serial number of the computing device to the device manufacturer;
receiving a certified public key on the basis of the serial number; and
verifying the cryptographic signature using the certified public key.

7. The method of claim 5, wherein determining the identifier is linked to the computing device comprises:
receiving a public key from the device manufacturer;
accessing a preinstalled cryptographic signature on the computing device of the public key and a serial number; and
verifying the cryptographic signature using the public key.

8. The method of claim 6 comprising receiving the public key via an out-of-band communication channel from the device manufacturer.

9. The method of 1, comprising:
generating a challenge in a challenge and response protocol between the computing device and a further device, on the basis of at least the cryptographic key;
communicating the challenge to the further device; and
authenticating a user of the further device, on the basis of a response received at the computing device.

10. The method of claim 9, wherein the challenge is communicated through a Quick Response (QR) Code displayed by the computing device.

11. The method of claim 8, wherein the user is authenticated to perform Basic Input/Output (BIOS) management operations on the computing device in response to a user successfully authenticating to the computing device.

12. An apparatus comprising:
a trusted platform module;
a cryptographic key generation module, communicatively coupled to the trusted platform module, to generate cryptographic keys; and
a processor communicatively coupled with the trusted platform module, to execute a trusted boot process in cooperation with the trusted platform module
wherein the processor authenticates cryptographic keys generated by the cryptographic key generation module during the trusted boot process, on the basis of an identifier securely stored on trusted platform module.

13. The apparatus of claim 12, wherein the trusted platform module is arranged to verify integrity of operations performed by the processor during the trusted boot process.

14. The apparatus of claim 12, comprising a basic input/output system (BIOS) management module communicatively coupled to the processor.

15. A non-transitory machine-readable storage medium encoded with instructions executable by a processor, to:
retrieve a hardware-based digital signing key from a secure storage on a computing device; and
authenticate a cryptographic key generated according to a cryptographic key generation algorithm, during a boot process of the computing device, on the basis of the hardware-based digital signing key.
